(19) United States
(12) Patent Application Publication
(10) Pub. No.: US 2024/0294406 A1
(43) Pub. Date: Sep. 5, 2024

(54) System And Method For Wastewater Treatment Including Use of Microporous Media Beds

(71) Applicant: Agsmart, Inc., Strasburg, CO (US)

(72) Inventors: Loren L. Losh, Strasburg, CO (US); Michael Walvoord, Katy, TX (US); Richard G. Hicks, Cypress, TX (US)

(21) Appl. No.: 18/177,663

(22) Filed: Mar. 2, 2023

(51) Int. Cl. C02F 1/463; B01D 17/06; B01D 19/00; B01D 21/01; B01D 21/06; B01D 21/08; B01D 21/24; B01D 24/00; B01D 61/14; B01D 61/16; B01D 61/18; B01D 61/20

(52) U.S. Cl. CPC C02F 1/463; B01D 17/06; B01D 19/0073; B01D 21/01; B01D 21/06; B01D 21/08; B01D 21/2405; B01D 24/00; B01D 61/1471; B01D 61/16; B01D 61/18; B01D 61/20; B01D 61/22; B01D 2101/04; B01D 2257/91; B01D 2321/42

(57) ABSTRACT

The invention provides water treatment for a municipal wastewater source by removal of contaminants including nutrient contaminants, FOG, total suspended solids, pathogenic bacteria, viruses and metal contaminates. Pathogenic bacteria and viruses are removed without the use of chlorine contact, ultraviolet treatment or reverse osmosis treatment. The treatment steps may include: oxygenation by single cell algae, electrocoagulation, precipitation of solids, absorption and flocculation, de-aeration, metered amounts of an anionic or cationic flocculant added for further coagulation and precipitation of coagulated material; mixing and subsequent clarification; sand filtration; and removal of remaining contaminants by containers housing microporous media beds or ion-exchange beds. The treatment steps may be used in various combinations and sub-combinations in order to focus treatment on prevalent contaminants in the wastewater to be treated. The invention further includes embodiments of the media bed containers and a non-transitory computer-readable medium to execute a method for conducting treatment of a wastewater stream.

### FIELD OF THE INVENTION

The system and method of the invention utilize multiple sequential treatment technologies to provide removal of various contaminants from a municipal wastewater source including nutrient contaminants, total suspended solids (TSS), microorganisms including bacteria and viruses.

### BACKGROUND OF THE INVENTION

The treatment of municipal wastewater provides a continuing challenge for most public municipalities considering the ever-changing regulations which limit the type and quantities of contaminants that may be returned to waterways. Further, wastewater treatment for public wastewater systems also provides challenges to such municipalities because water quality standards continue to trend in favor of lowering levels of contaminants. With respect to well-known wastewater treatment systems for purposes of treating wastewater, common treatment steps include coagulation, flocculation, sedimentation and filtration. Most public wastewater treatment systems also include a disinfection process by adding chemical disinfectants such as chlorine, chloramine, or chlorine dioxide. Other disinfection steps may include ultraviolet exposure or ozone exposure.

Animal feeding operations, including concentrated animal feeding operations (CAFOs), produce large quantities of waste that affect both air and water quality in surrounding geographical areas. Waste from such operations may be initially treated in a treatment pond or lagoon in which aerobic and anaerobic processes take place to remove particular nutrient contaminants. In addition to CAFO's, a municipality generally has to deal with wastewater from various sewage sources, including industrial waste sources, storm water runoff and septic tank waste. Further, domestic wastewater produces other types of contaminants to include metal contaminants that may be particularly difficult to remove from a wastewater stream.

Considering the diverse sources of wastewater and the multitude of different contaminants that may require removal by a municipal wastewater treatment facility, there is a need for a wastewater treatment system and method that may be capable of handling a very wide variety of contaminants including, but not limited to, nutrient contaminants, fats, oil and grease (FOG), TSS, microorganisms, and metal contaminants, so that discharged water from the treatment facility complies with ever stricter regulatory requirements.

In accordance with the present invention as explained in connection with the following description and drawings, the system and method disclosed herein addresses the ever changing and stricter discharge requirements set forth by local, state, and federal regulations. Further, the present invention provides a system and method for water treatment which is capable of treating water discharged from many different wastewater sources without substantially altering the basic equipment and method used.

### SUMMARY OF THE INVENTION

The invention utilizes multiple sequential treatment technologies to provide removal of various contaminants including, but not limited to, nutrient contaminants, FOG, TSS, pathogenic bacteria, viruses and metal contaminates from a municipal wastewater source. The removal of pathogenic bacteria and viruses is accomplished without the use of chlorine contact, ultraviolet treatment or reverse osmosis treatment.

The treatment steps in accordance with one or more embodiments of the invention may include the following treatment steps: oxygenation by single cell algae, electrocoagulation, precipitation of solids, absorption and flocculation, primarily using gravity as the means for separating liquids and solids in the arriving wastewater stream; de-aeration introduction of a metered amount of an anionic or cationic flocculant for further coagulation and precipitation of previously coagulated material; mixing and subsequent clarification; sand filtration; and removal of remaining contaminants by containers housing microporous media bed or ion-exchange bed materials. The treatment steps may be used in various combinations and sub-combinations in order to focus treatment on prevalent contaminants in the wastewater to be treated. Further, the treatment steps may be used in different sequential orders to best treat a particular group of contaminants; therefore, the invention is not specifically limited to any particular order of treatment steps. The invention further includes embodiments of the media bed container and a non-transitory computer-readable medium to execute a method for conducting treatment of a wastewater stream.

A first optional step in the system and method of the invention is aerobic treatment of a wastewater stream by use of multiple species of single cell microalgae that efficiently produce significant amounts of oxygen. The microalgae are typically introduced into a standing body of water such as a waste treatment pond or lagoon at a municipality where water treatment takes place. The source of the waste may, for example, be from a CAFO. Oxygen levels are monitored in the treatment and microalgae are introduced into the lagoon at metered amounts to satisfy minimum oxygen levels. The oxygenation of waste in the lagoon satisfies the biochemical demand to reduce organic contaminants as well as providing oxidation of other contaminants. Delivery of the microalgae at desired quantities and rates is achieved by a microalgae delivery system in which microalgae are grown and stored in greenhouse-like conditions. More specifically, growing of the microalgae is facilitated by an engineered greenhouse structure which optimizes growth conditions for the microalgae that is contained in multiple growth or culture tanks. Selected species of microalgae are grown in the tanks and then delivered automatically to one or more treatment lagoons. The microalgae are introduced into the lagoon through dispersion nozzles that may be strategically placed at desired locations and depths within a lagoon such that the oxygen transfer rate (OTR) is close to a 99% for the entire water column or depth of the lagoon. This oxygen saturation for the entire water column is much more efficient for delivering oxygen to a treatment lagoon in which traditional subsurface aeration may typically result in only about a 15% OTR, and to achieve such an OTR level, high amounts of energy are required to run various pumps and aerators that may be installed in the lagoon. The particular layout or design of a lagoon may include a series of baffles, micro-diffuser plates or diverters so that water flowing through the lagoon follows a torturous path to maximize the residence time of the wastewater before it passes downstream.

Another optional treatment step in the system and method of the invention includes wastewater treatment by electrocoagulation, precipitation of solids, absorption and flocculation, primarily using gravity as the means for separating liquids and solids in the arriving wastewater stream. This treatment step may be generally referred to herein as electrolytic treatment. Electrocoagulation in water treatment is used to remove solids, sometimes referred to as TSS, emulsified oils, metal contaminants, and various microorganism contaminants including bacteria pathogens such as E. Coli . . . . Multiple chemical reactions take place in an electrocoagulation unit to achieve treatment. Metal ions are released into the water passing through the electrocoagulation unit as a result of an anode/cathode or electrode arrangement of metallic plates immersed in the water, the ions being released as a result of an electric current applied across the electrode arrangement. Specifically, water is hydrolyzed into various hydroxyl groups and hydrogen gas. At the same time, electrons flowing within the electrocoagulation unit help to destabilize surface charges on suspended solids and emulsified oils. The reaction continues with flocculation that results in entrainment of many contaminants including metals, emulsified oils, suspended solids, and microorganism contaminants. The flocs are removed in downstream solid separation and filtration steps. In accordance with the electrolytic treatment of the present invention, this step involves application of a low-voltage, high amperage direct current charge to sacrifice metallic ions such as iron and aluminum and placing these ions in solution while simultaneously liberating hydrogen and oxygen gas. The dissolved metals and other suspended material present in the wastewater react with the sacrificial ions and gases resulting in the contaminants being precipitated from the solution in the form of acid resistant, metallic oxide complexes. After precipitation, the contaminants are removed in a downstream clarifier. One preferred electrocoagulation protocol is to only add cationic iron without anionic enrichment that considerably reduces the amount of sludge produced in the electrolytic reaction. More specifically, iron is sacrificed from the electrodes in a ferrous oxidation state and hydrolyzes to the ferric state where it then precipitates as ferrous hydroxide. Both colloidal and dissolved contaminates are adsorbed onto the oxyhydroxide floc and are co-precipitated by occlusion into an amorphous iron hydroxide sludge. Phosphates are also more simultaneously precipitated.

According to one preferred embodiment, one flow path or flow train of the system includes a single or multiple electrolytic reactors arranged in parallel.

According to another preferred embodiment, multiple electrolytic reactors may be used for a multiple path arrangement in order to handle larger flow rates of incoming wastewater, wherein the multiple reactors can be arranged in any desired combination of serial and parallel flow paths.

Another optional treatment step in the system and method of the invention includes a de-aeration step in which the contaminant stream is de-aerated. One preferred device or component is a post reaction vessel which could be a large holding tank with a heavy duty, top mounted mixer. The mixer slowly and continuously agitates vessel contents to disperse active flocculate and to subsequently de-aerate the wastewater stream prior to entering the next treatment step, namely, clarification. The goal of treatment within the reaction vessel is to ensure all electrolytic reactions are complete and all entrained gases have been dissipated. A pH control component communicates with the vessel to continuously monitor the pH of the wastewater stream. Specifically, a pH monitor measures the pH level of the wastewater stream and an injector connected to the vessel will deliver a selected alkaline substance or acidic substance to adjust the pH to the desired level within the vessel.

Another optional treatment step in the system and method of the invention is the introduction of a metered amount of an anionic or cationic flocculant into the waste stream for purposes of further coagulation and precipitation of previously coagulated material from the post reaction vessel. According to one preferred embodiment, the flocculant may be an anionic or cationic flocculant polymer that is first treated by a polymer mixing device that is especially adapted for diluting and aging emulsion polymers into fully activated and uniformly diluted polymer solutions. One example of the mixing device could be a Polymixer unit from Hoffland Environmental, Inc. (HEI). This type of mixing device continuously mixes a specified amount of a selected polymer in a chamber where it is blended and mixed with an amount of dilution water. The resulting solution flows through a series of internal, concentric chambers providing time for the polymer solution to age and activate before being injected into a downstream clarifier holding the wastewater. Accordingly, the flocculant polymer solution provides a fully active polymeric strand to attract the previously coagulated material.

Another optional step in the system and method of the invention is transfer of the waste stream to a multi-function clarifier tank where further mixing occurs along with clarification after mixing. Specifically, the waste stream is transferred to the multi-function clarifier tank that is also equipped with a flash mixer which can be described as a heavy-duty medium shear mixing device to mix or agitate the waste stream carrying the flocculant polymer solution in order to further disperse the polymer in the waste stream. The flocculant polymer solution is first mixed within an adjacent flash mix container within the clarifier tank. The clarifier tank further includes an inclined plate which, along with a flash mix compartment of the flash mixer, provides a rapid mixing rate within a relatively short period of time. The conditioned wastewater stream from the flash mix container then flows into a larger flocculation tank within the multi-function clarifier tank where a slow-moving picket fence agitator blends the activated polymer into conditioned wastewater to create a more settable solid for removal in an inclined plate section that is positioned within the clarifier tank below the flocculation tank. The conditioned, flocculated wastewater flows by gravity from the flocculation tank into a compartment of the inclined section through specially designed flow channels to enhance distribution with quiescence to a number of settling plates making up the inclined plate section.

Another optional treatment step in the system and method of the invention includes clarification in the clarification tank or vessel. The primary goal in the clarification tank is separation of solids from the liquid wastewater stream. The wastewater stream has a sufficient retention time within the clarification tank to enable suspended solids to settle out of the waste stream and collect on the bottom surface of the clarification tank.

The flocculated waste solids flow by gravity into the main chamber of the clarifier tank. Preferably, the main chamber is cylindrical shaped with a sloped section at the bottom surface thereof to enhance gravity flow of the waste solids or sludge to a collection well at the bottom of the tank. The clarifier tank may be outfitted with a sludge movement rake enabling the collected solids to move more efficiently from the tank perimeter to the central collection well. A motor drives the sludge movement rake which rotates at a rate not to exceed eight (8) revolutions per hour to increase the solids content but prevents re-mixing of the solids with the wastewater which might otherwise occur if the rotation rate of the rake is high enough to cause an uplift of the solids into the wastewater flow. Over time, gravity forces the solids to concentrate to therefore achieve the desired liquid-solid separation effect. A top layer of the wastewater is allowed to overflow a weir located on an upper surface of a portion of the clarifier tank in order to proceed downstream to a next treatment step. The weir more specifically may be a launder weir which is a plate that has a series of v shaped notches to ensure there is a uniform flow rate of the wastewater stream and to prevent uncontrolled volumes of wastewater passing over the weir in the event there are slight variations in the depth of the wastewater in the clarification tank. The thickened solids that collect at the bottom of the clarification tank are removed from the tank by a sludge pump that communicates with an opening at the bottom of the tank.

Another optional treatment step in the system and method of the invention includes further liquid-solid separation step in one or more sand filter units located downstream of the clarification tank. More specifically, a sand filter unit is used to effect further TSS and debris removal by pressurization of the wastewater flow through a sand-filled filter unit. The sand filter unit utilizes a short bed filtration function to retain suspended solids up to 20 microns. As solids such as TSS or other debris build up within the sand filter unit, the pressure within the housing of the sand filter unit increases thereby indicating a need for the housing to be flushed out. Pressure sensors incorporated in the housing will trigger an automatic backwash of water through the sand filter unit to flush out trapped solids in the housing. More specifically, the backwash process is triggered by a difference in the set points of the measured pressure at the inlet and the outlet of the sand filter housing.

Once the backwash process is completed, the sand filter unit will come back online for normal operations.

Another optional step in the system and method of the invention includes sludge thickening which is intended to gravity concentrate and decant waste sludge. One example of a sludge thickening device according to a preferred embodiment of the invention includes the use of a HEI ST-10/7000 sludge thickener. The HEI sludge thickening device is a tank equipped with a motorized sludge rake and a sludge discharge pump. The sludge rake is used to thicken the solids and to positively move the heavy solids to a center area of the sludge tank over a center drain. The discharge from the sludge thickening device is pumped to an inlet of a solids tank where the non-hazardous solids are temporarily stored until transported to a waste disposal facility.

Another optional treatment step, which could be a final treatment step, includes removal of remaining contaminants by use of microporous media bed or ion-exchange bed using microporous materials. One preferred type of microporous materials that can be used include aluminosilicate minerals such as zeolite. This final treatment step is intended to remove nutrient contaminants including ammonia, nitrates, nitrites and phosphates. According to a preferred embodiment, the media bed includes a multi-channeled flow structure that is used to optimize exposure of the waste stream to the filtering media for the final removal of the remaining nutrient contaminants before the waste stream is discharged into state or federal receiving waters. The media bed more specifically has at least three channels in which the wastewater flows in changing directions around two bends. The channels provide an optimum maximum retention time of the wastewater stream so that the ion-exchange can be thoroughly executed. The bends in the flow structure result in maximizing water contact with the media and eliminating channeling, or short-circuiting flow, through the media from the inlet to the outlet flow which ensures that the entire water column of the wastewater stream is placed in contact with the media bed.

It is also contemplated that the contaminant laden media can be regenerated in a brine backwash system, thus providing a cost savings in use of the media material. A brine solution is prepared for media regeneration using the media mover to dissolve sodium chloride in a drinking water source and loading the brine tank with the solution. The brine tank can be further circulated using the pump skid, discussed below, to ensure the brine salt is fully in solution. After the brine solution is prepared, the pump skid is used to circulate the brine through the media filter tank. Upon completion of the regeneration step, the brine is pumped back into the brine tank for pick up and disposal off site.

Located between the media mover and the brine storage tanks is a multi-function pumping station or pump skid. The pump skid provides many flow paths for the brine for purposes of regenerating the zeolite or other media. Specifically, the pump skid can be used to pump water to load zeolite, or other media, into the media bed or to pump brine into the brine tank. The pump skid may also be used to recirculate the brine in the brine tank while the brine is being loaded. When regenerating the zeolite after it passes through the media filters, one flow path through the pump skid is a continuous loop from the media bed to the media filters, then to the brine tank and finally a return flow to the media bed. The pump skid can also control flow of waste brine from the brine tank to collection for disposal.

The system of the invention is controlled automatically, manually, or a combination of the two. According to one preferred embodiment, automatic system control is achieved by the use of one or more computers, which may include programmable logic computers (PLCs) that are especially adapted for industrial use in which input/output modules are capable of receiving a wide array of different electrical inputs and outputs in order to control a plurality of field devices of the system. Also, according to automatic control, the system provides a number of user interfaces in the form of screen displays that may be viewed by the user in order to select system parameters, to monitor the system, and to record data reflective of the operation of the system. One or more control panels may house the PLC of a system. Alternatively, system control may be achieved remotely in which control by the one or more computers or PLCs communicates remotely with an installed system and therefore, the invention also contemplates the use of a communication system such as the Internet or local intranets. In accordance with manual control of the system, user interfaces may also be provided for a user to monitor and override system control, such as may be necessary if a system component is required to be replaced or repaired, in such case the system may be temporarily unavailable for use. Further, the invention also contemplates selective combinations of automatic and manual control in which it may be desirable to provide automatic control for some of the system components while at other times, it may be desirable to provide manual control for other system components. One convenient arrangement for controlling the various electrical motors or pumps of the system includes the use of one or more central control panels which may house various electrical components including motor starters, relays, switches, and circuit breakers. The central control panels may be located with a system installation in a building. Alternatively, the central control panels can be located remote from the system installation in another building or other facility. The control system of the invention also contemplates the incorporation of various alarms in which equipment failure or system operation which fails for one or more reasons may be quickly notified as to the source of the problem along with predetermined or preset alarm notifications which may instruct an operator on how to proceed considering the alarm condition.

Considering the foregoing description, the invention in one embodiment may be considered a system for wastewater treatment comprising: an aerobic pre-treatment station including at least one fluid containment cell which holds and circulates wastewater to be treated therein, said aerobic pre-treatment station including a selected quantity and concentration of single cell algae introduced into the wastewater wherein said algae facilitates aerobic treatment of the wastewater; an electrocoagulation unit that receives wastewater from a quiescent pond, said pretreatment station, said electrocoagulation unit providing further treatment of the wastewater to remove selected contaminants including, but not limited to, TSS, FOG, pathogenic bacteria, viruses, metals, emulsified oils, and other contaminant microorganisms; a post reaction tank for receiving the wastewater from said electrocoagulation unit, said post reaction tank having means for agitating the wastewater therein to disperse active flocculate introduced from said electrocoagulation unit and to subsequently de-aerate the wastewater; a clarifier tank for receiving the wastewater from said post reaction tank, wherein said clarifier tank separates solids from liquid in said wastewater and said solids settle out of the wastewater and are collected on a bottom surface of said clarifier tank; a sand filter for receiving a pressurized flow of said wastewater from said clarifier tank, said sand filter causing further removal of TSS by pressurization of the wastewater flow through said sand filter; a media tank for receiving the wastewater from said sand filter, said media tank having a plurality of passageways in which said passageways direct flow of the wastewater therethrough, said media tank being selectively loaded with a quantity of microporous material for absorbing contaminants including cations; and wherein said plurality of passageways being arranged such that wastewater flows through a first passageway of said plurality of passageways in one direction, and the wastewater flows through a second passageway in a substantially opposite direction, and further wherein said wastewater flows in a curved pattern between a downstream end of said first passageway and an upstream end of said second passageway.

According to another embodiment of the invention, it may be considered a method for water treatment comprising: providing an aerobic pre-treatment station comprising at least one fluid containment cell which holds wastewater to be treated therein, said aerobic pre-treatment station including a selected quantity and concentration of single cell algae introduced into the wastewater wherein said algae facilitates aerobic treatment of the wastewater; continuously circulating the wastewater in said fluid containment cell to optimize contact of the wastewater with the algae; an electrocoagulation unit receives wastewater from said quiescent pond aerobic pretreatment station; conducting electrocoagulation in said electrocoagulation unit to provide further treatment of the wastewater to remove selected contaminants including but not limited to, TSS, pathogenic bacteria, viruses, metals, emulsified oils, and contaminant microorganisms; providing a post reaction tank for receiving the wastewater from said electrocoagulation unit; agitating the wastewater in said post reaction tank to disperse active flocculate introduced from said electrocoagulation unit and to subsequently de-aerate the wastewater; providing a clarifier tank for receiving the wastewater from said post reaction tank; separating solids from liquid in the wastewater while the wastewater resides in the clarifier thank; collecting the solids that settle out of the wastewater on a bottom surface of said clarifier tank; providing a sand filter for receiving the wastewater from said clarifier tank; providing a pressurized flow of the wastewater through said sand filter causing further removal of contaminants including TSS; providing a media tank for receiving the wastewater from said sand filter, said media tank having a plurality of passageways in which said passageways direct flow of the wastewater there through; loading said media tank with a selected quantity of microporous material for absorbing contaminants including cations; providing a first passageway of said plurality of passageways causing the wastewater to flow in one direction; providing a second passageway of said plurality of passageways causing the wastewater to flow in a substantially opposite direction; and providing a curved passageway located between a downstream end of said first passageway and an upstream end of said second passageway causing the wastewater to flow in a curved pattern there through.

According to yet another aspect of the invention, as a sub-combination or as a separate element from the treatment system, the invention in yet an embodiment can be considered a media tank for receiving wastewater from an upstream filter or some other water treatment element. The media tank has a plurality of passageways that direct flow of the wastewater through the media tank; said media tank being selectively loaded with a quantity of one or more types of microporous materials for absorbing contaminants and cations; and wherein said plurality of passageways are arranged such that the wastewater flows through said plurality of passageways in differing directions to increase the amount of time in which the wastewater is exposed to the microporous material. The plurality of passageways are arranged such that wastewater flows through the passageways in differing directions that can be alternately viewed as flow of the wastewater in one or more curved patterns.

According to yet another aspect of the invention in yet another embodiment, it may be considered a non-transitory computer-readable medium containing computer executable instructions, wherein, when executed by a computer processor, the instructions cause the computer processor to execute a method for conducting water treatment of a wastewater stream or flow within a wastewater treatment system, the computer-readable instructions comprising: instructions to monitor and control an aerobic pre-treatment station comprising at least one fluid containment cell which holds wastewater to be treated therein, said aerobic pre-treatment station including a selected quantity and concentration of single cell algae introduced into the wastewater wherein said algae facilitates aerobic treatment of the wastewater; instructions to monitor and control an electrocoagulation unit that receives wastewater from said aerobic pretreatment station; instructions to monitor and control the electrocoagulation conducted in said electrocoagulation unit to provide further treatment of the wastewater to remove selected contaminants; instructions to monitor and control a post reaction tank for receiving the wastewater from said electrocoagulation unit to disperse active flocculate introduced from said electrocoagulation unit and to subsequently de-aerate the wastewater; instructions to monitor and control a clarifier tank for receiving the wastewater from said post reaction tank; instructions to monitor and control the separation of solids from liquid in the wastewater while the wastewater resides in the clarifier thank; instructions to monitor and control a sand filter for receiving the wastewater from said clarifier tank wherein a pressurized flow of the wastewater through said sand filter causes further removal of contaminants; instructions to monitor and control a media tank for receiving the wastewater from said sand filter, said media tank having a plurality of passageways in which said passageways direct flow of the wastewater there through; instructions to monitor and control loading of said media tank with a selected quantity of microporous material for absorbing contaminants; and instructions to generate a plurality of outputs to one or more user screens on one or more computing devices that run said non-transitory computer-readable medium; instructions to generate a plurality of outputs to one or more user screens on one or more computing devices that run said non-transitory computer-readable medium, said outputs including visual displays that show (a) a status of each selected component of said treatment system (b) an alarm status for any of said components that may not be operating within predetermined parameters; and (c) an indication of the volume of wastewater being treated and discharged from the treatment system.

Additional features and functions of the invention will become apparent from a review of the following detailed description and accompanying drawings.

### BRIEF DESCRIPTION OF THE DRAWINGS

FIG. 1 is a schematic diagram of a pretreatment step of the invention in which the wastewater stream may undergo microbial treatment, such as aerobic treatment by use of multiple species of single cell microalgae that efficiently produce significant amounts of oxygen;

FIG. 2 is a schematic diagram of the invention showing various components that are used to provide water treatment, noting that a dual flow path is provided for a wastewater stream in which two separate treatment paths are provided, each path having its own treatment components;

FIG. 3 is a schematic diagram of the invention showing additional structural features and capabilities of the invention including sand filtration and contaminant absorption by use of microporous media beds;

FIG. 4 is a perspective view of an embodiment of a media bed container or media tank of the invention;

FIG. 5 is a top plan view of the media bed container of FIG. 4;

FIG. 6 is an elevation view of an inlet side of the media bed container of FIG. 4;

FIG. 7 is an elevation view of an outlet side of the media bed container of FIG. 4;

FIG. 8 is a perspective view of a media material loading and transfer station for replenishing media material of the media bed container;

FIG. 9 is a perspective view of a pumping station, or pump skid, that is used to route and control the flow of the brine backwash stream and to load the media material through the system of the invention;

FIG. 10 is a schematic plan view of the pumping station of FIG. 9 showing four circulation routes or paths of fluid through the system of the invention;

FIG. 11 is a perspective view of another embodiment of the media bed container of the invention with the sidewalls of the container removed to show a plurality of diverter plates used within the flow passages of the container in order to better mix the contaminant fluid stream with the media material as the contaminant fluid flows through the container, and

FIG. 12 shows a communication and control system of the invention.

### DETAILED DESCRIPTION OF THE INVENTION

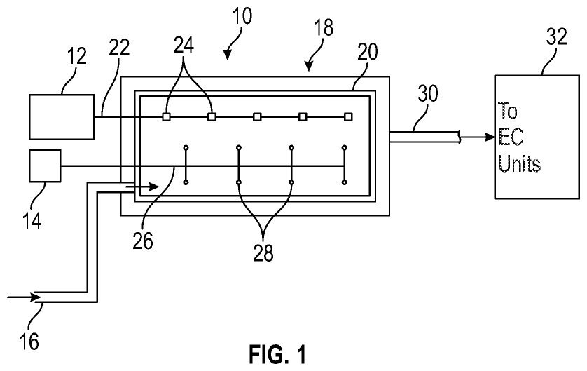

Referring first to FIG. 1, a schematic diagram is shown of an optional pretreatment station 10 in which the wastewater stream may undergo microbial treatment, such as aerobic treatment by use of multiple species of single cell microalgae that produce significant amounts of oxygen. The microalgae may be introduced into a standing body of water such as a waste treatment pond or lagoon 18. The lagoon 18 may have an impervious liner or barrier 20 to prevent wastewater seepage into the ground which could otherwise contaminate a groundwater source. Baffles can be added to the lagoon to create a controlled pathway to eliminate short circuiting flow of the wastewater stream from entry to discharge. The microalgae may be introduced into the lagoon 18 from an algae producing source 12, such as a facility that grows and cultivates a desired species of the microalgae. For example, the micro algae can be grown in a greenhouse structure that optimizes growing conditions for a desired number and type of microalgae species. The microalgae can be introduced into the lagoon 18 by an algae distribution line 22 at a number of distribution points 24 that are spaced about the lagoon. In addition to the algae, additional oxygen can be introduced into the lagoon through a compressed air source 14 which is capable of pumping compressed air into the lagoon through a distribution line 26. A plurality of compressed air distribution points 28 are dispersed throughout the lagoon as shown. The introduction of compressed air or forced air into the lagoon also creates a mixing effect in the lagoon that further assists in distributing oxygen in the lagoon as well as further distributing microalgae. The pretreatment station 10 is to be understood as being optional in the present invention, understanding that some wastewater sources may not require pretreatment.

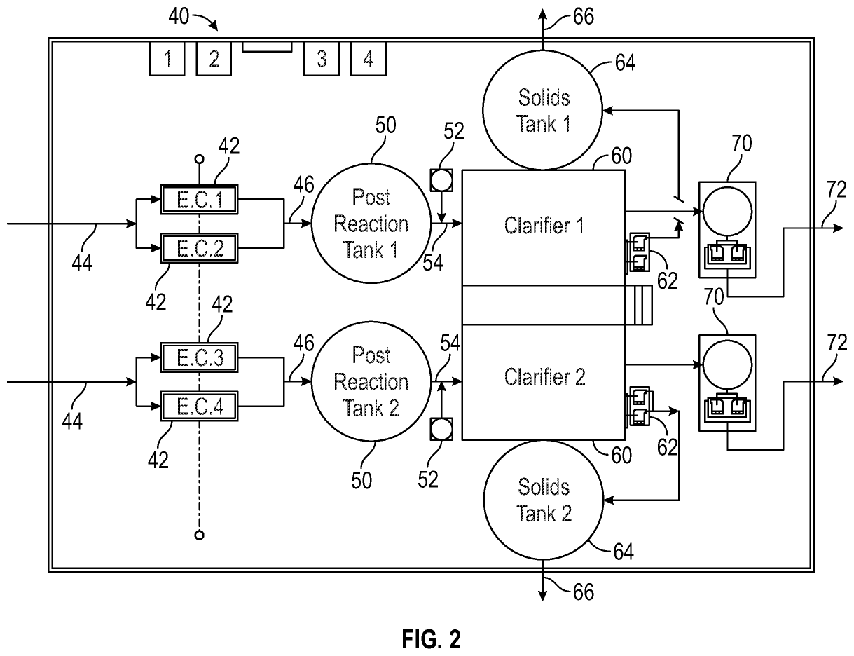

Referring next to FIG. 2, this figure provides a schematic diagram of the invention showing the various components that are used to provide water treatment. According to one preferred embodiment of the invention, this figure shows that there are two distinct flow paths for the wastewater to be treated in which system components are provided to separately treat the wastewater within the two distinct flow paths. There are a number of advantages to providing a redundant, dual path treatment system First, the volume of wastewater that can be treated is doubled by having the distinct flow paths. Second, if a component of one flow path treatment requires maintenance, the system can still provide some treatment capacity through the other flow path that is not undergoing maintenance. Third, in the event the wastewater is arriving from two separate sources, each flow path can be specifically tailored or designed in order to optimally treat the separate sources. In this regard, it may be necessary, for example, to provide greater treatment with respect to removing metals in the wastewater, in which case one flow path may increase the dwell time that the wastewater passes through an electrocoagulation unit to therefore increase removal capability.

Although a dual flow path configuration is provided, it shall also be understood that according to other embodiments of the invention, there may be a single flow path or there may be more than two flow paths, depending upon the sources of wastewater and the rate at which the wastewater must be treated.

The description that follows sets forth a discussion of elements within a single flow path, it being understood however by a review of FIG. 2 and the subsequent figures that there are two flow paths with mirrored components or elements, each of which serve the same corresponding functions.

The wastewater arrives to the treatment system 40 by an inlet line 44. The inlet flow of the wastewater then follows a single flow path or is split into multiple flow paths that introduce the wastewater into an adjacent electrocoagulation unit(s) 42 arranged in parallel. Because of the amount of time required to conduct effective electrocoagulation, multiple electrocoagulation units are provided to increase the efficiency and thoroughness of the treatment which takes place. As mentioned, electrocoagulation may be used to remove a wide range of contaminants to include, but not limited to, TSS, pathogenic bacteria, viruses, emulsified oils, metal contaminants, and various other microorganisms.

After electrocoagulation, the treated wastewater is discharged through lines 46 and is then introduced into a next treatment device, namely, a post reaction tank or vessel 50 for purposes of conducting deaeration. The post reaction vessel 50 may be a large holding tank with a top mounted mixer (not shown). The mixer slowly and continuously agitates vessel contents in the vessel to disperse active flocculate generated by the electrocoagulation units. The purpose of the post reaction vessel is to remove the flocculate and to therefore minimize the amount of dissolved in trained gases and bubbles in the wastewater prior to moving the wastewater to the next treatment step. Further, another purpose of treatment within the reaction vessel, as previously mentioned, is to also enable additional time for completion of electrolytic reactions which will also help in dissipating entrained gases. The pH of the wastewater with the reaction vessel is controlled to by delivering a selected alkaline substance or acidic substance to adjust the pH to a desired level.

The wastewater from the post reaction vessel is discharged through line 54 into a clarifier 60. Prior to the wastewater entering the clarifier 60, a metered amount of an anionic flocculant polymer may be introduced into the wastewater by a polymer mixing unit 52. The introduction of the anionic or cationic flocculant polymer should be understood as another optional treatment step in accordance with another embodiment of the invention. The anionic or cationic flocculant polymer provides coagulation and precipitation of previously coagulated material from the post reaction vessel. The polymer mixing unit 52 may be used to introduce the anionic or cationic flocculant polymer. This mixing device is used for diluting and aging emulsion polymers into fully activated and uniformly diluted polymer solutions. The primary function of the mixing unit 52 is to provide a fully active polymeric strand to attract the previously coagulated material in the wastewater. A return line (not shown) is provided from the bottom of the clarifier to the post reaction tank to introduce a specific amount of this sludge to enhance the polymer flocculation process.

The clarifier tank 60 allows for further mixing of the wastewater in which the clarifier tank may include a flash mixer to adequately mix or agitate the wastewater carrying the flocculant polymer. The clarifier tank 60 also may optionally include an inclined plate which, along with a flash mix compartment of the flash mixer, provides a rapid mixing rate within a relatively short period of time. The primary purpose of the clarifier tank is to separate suspended solids from the liquid wastewater stream in which the solids separate by gravity and collect on the bottom surfaces of the tank. According to one preferred embodiment, the clarifier tank may have a cylindrical shaped main chamber with a sloped section at the bottom surface thereof to enhance gravity flow of the solids into a collection well located at a central bottom portion of the tank. A sludge movement rake (not shown) may be installed within the tank to move collected solids from the tank perimeter to the central collection well. As time progresses, gravity forces the solids to concentrate to therefore achieve the desired liquid-solid separation effect. A top layer of the wastewater overflows a weir located on an upper surface of a portion of the clarifier tank in order allow some of the wastewater to proceed downstream to the next treatment step. The top layer or portion of the wastewater constitutes that portion of the wastewater within the clarifier tank that has achieved the greatest degree of liquid solid separation. The weir more specifically may be a launder weir. The thickened solids that collect at the bottom of the clarification tank are removed from the tank by a sludge pump 62 that communicates with an opening at the bottom of the tank 60. The sludge pump 62 moves the collected solids or sludge to a solids tank 64 where sludge thickening occurs and the solids are subsequently collected for further settling/concentration and removal. A sludge discharge line 66 communicates with, for example, a sludge removal vehicle (not shown) that can be used to haul the sludge offsite to a waste disposal site. Although each flow path shows a dedicated solids tank 64, it should be understood that a single solids tank can be used to service both flow paths. In order to enhance the polymer flocculation process within the polymer mixing unit 52, the system may optionally include a return line (not shown) that transports a desired amount of sludge from the bottom of the clarifier tank 60 to the post reaction tank 50.

Optionally, sludge thickening can be carried out in which the solids collected in the solids tank 64 are subjected to gravity concentration and decantation. In a preferred embodiment, the sludge thickening device (not shown) may be a tank equipped with a motorized sludge rake and a sludge discharge pump. The sludge rake is used to thicken the solids and physically displace the heavy solids to a center area of the sludge tank over an evacuation drain. The discharge from the sludge thickening device is pumped to the inlet of the solids tank 64 where the non-hazardous solids are temporarily stored until transported to a waste disposal facility.

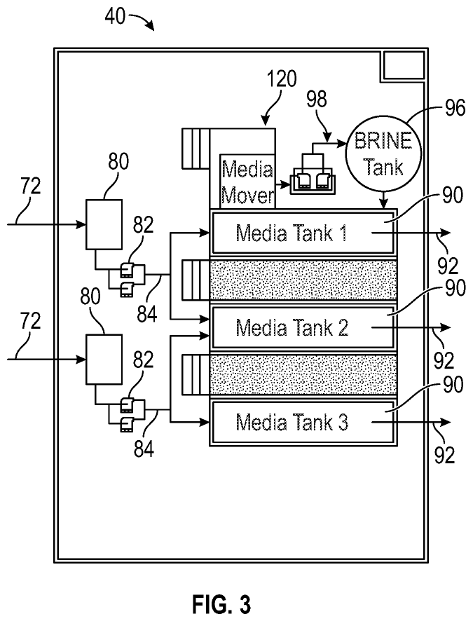

The wastewater treated in the clarifier tank 60 is then moved downstream through a pump station 70 and then downstream to one or more treatment components. The pump station 70 also facilitates routing of the wastewater for further downstream treatment through the sand filters 80 and the media tanks 90, as discussed further below. One purpose of the pump station 70 is to pressurize water flow in order to compensate for head losses in the wastewater flow as it is treated through the electrocoagulation units 42, post reaction tank 50 and clarifier 60. There is optimally a balanced flowrate of wastewater through the system in order to maximize the rate of treatment yet not to create excessive backflow or stagnation of the wastewater at any particular treatment component. The pump station includes at least two pumps. Referring next to FIG. 3, a discharge line 72 carries the wastewater from the pump station 70 to the next optional treatment component, namely, further liquid-solid separation by a sand filter 80. Sand filtration provides further TSS removal by a pressurized flow of the wastewater through a vessel that contains a stratified mix of sand and gravel. According to one preferred embodiment of the sand filter 80, the wastewater flows vertically through a bed of sand or gravel mixed with the sand. TSS removal is achieved through one or more actions in the sand filter. The first is filtration in which particulate matter is physically strained allowing liquid to pass. The second is where solids will adhere to the sand and gravel particles and any biological material that may be present on the sand and gravel particles. Because of the pressure or head loss associated with the passage of the wastewater through the sand filter, one or more transfer pumps 82 can be used to maintain wastewater flow downstream by discharge lines 84.

The final treatment component in the system and method of the invention includes removal of remaining contaminants by use of a microporous media bed or ion-exchange bed using microporous materials. As mentioned, one preferred type of microporous materials is aluminosilicate minerals such as zeolite however it should be understood that other microporous materials can be used. In one embodiment, the media bed includes a multi-channeled flow structure that is used to optimize exposure of the wastewater to the filtering media for the final removal of the remaining nutrient contaminants. One goal in use of the media beds is to maximize the exposure of the entire water column of wastewater flowing through the beds so that any stratification in the water column is broken up by diversion of the water column through the openings in diverter plates as discussed below. The media bed has a plurality of passages or channels through which the wastewater flows in changing directions, both horizontally and vertically. The channels provide optimum retention time of the wastewater stream so that the ion-exchange can be thoroughly executed.

Again, referring to FIG. 3, the discharge line 84 provides an inlet of the wastewater to two media tanks or media containing structures 90. FIG. 3 shows three media tanks 90 in which the dual flow of the wastewater downstream from the pair of sand filters 80 flows into the three media tanks. This particular arrangement of having an extra media tank 90 allows for an increase in the volumetric flow of the wastewater through the media tanks in which there is a slower volumetric flow so that the wastewater has enough retention time across the media beds for treatment. The extra or third media tank also allows for cleaning and regeneration of one of the media beds while the other two media beds can remain in operation. Therefore, there never has to be a complete shutdown of the wastewater flow through the system because of the redundant media beds 90. After the wastewater has undergone treatment within the treatment tanks, the fully treated wastewater is discharged downstream through outlets 92 and back to the state or federal receiving water bodies, and/or the source of municipal potable water.

As mentioned, the contaminant laden media that is contained in the flow channels of the media tank can be regenerated in a brine backwash system. The particular media tank undergoing media regeneration is taken out of service while the other media tanks may continue operation.

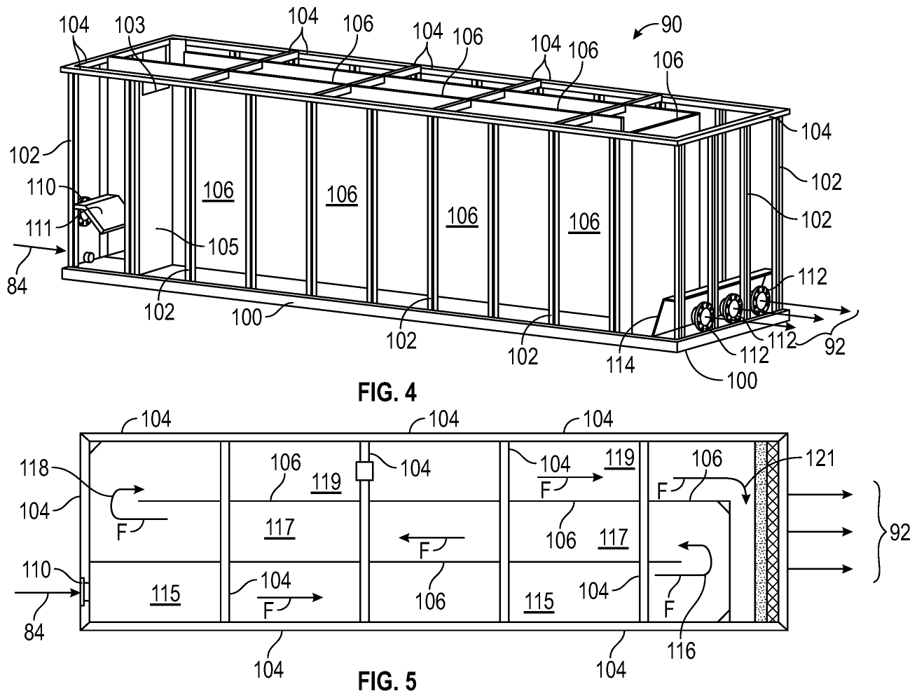

Referring to FIGS. 4-7, structural details are shown for one embodiment of the media tank 90 of the invention. Referring first to FIG. 4, the media tank 90 is illustrated with the exterior walls of the tank removed allowing one to see interior details. The media tank 90 comprises a base 100 that supports the tank and provides a surface for mounting of the interior and exterior walls, along with the various frame members. A plurality of vertical frame members 102 are shown to provide support for the exterior walls as well as providing support in connection points for upper frame members 104 and the plurality of interior walls 106. By use of the frame members 104 and 106, it is seen that substantial support is provided throughout all areas within the tank to thereby facilitate wastewater flow through the tank. A first passage wall 105 is provided to define an equalization chamber and an adjustable weir 103 that allows flow of the wastewater into a first compartment of the media tank. The inlet 110 is shown in the form of a pipe connection, it being understood that there is upstream piping (not shown) that interconnects the inlet 110 to an upstream component, such as the outlet lines 84. Located at the inlet 110 within the tank 90 is a diverter plate 111 which is used to slow the velocity of the incoming wastewater in which also facilitates settlement of solids. As the water continues to flow through the media tank 90, the wastewater is allowed to pass through one or more openings 107 formed in the passage wall 105. It should be understood that the passage wall 105 and openings 107 are optional and are provided for further slowing of the wastewater as it enters the tank 90.

Referring to FIG. 5, flow of the wastewater through the media tank is illustrated by flow arrows F. In one example of a flow pattern, the wastewater flows through a first linear or straight passageway 115, around a first bend or turn 116 into a second linear or straight passageway 117, through the second passageway 117 around a second bend or turn 118 and into a third linear or straight passageway 119. The wastewater flows through the third passageway 119 into a final bend or turn 121 and then out of the tank 90 through a plurality of outlets 92 defined by corresponding outlet pipe connections 112.

The group of passageways and turns provides for continuous contact of the wastewater with a sufficient area of the media bed so optimal treatment can take place. The bends or turns also encourages mixing of the wastewater throughout the water column so that stratified flow of the wastewater is minimized, thereby further enhancing contact of the wastewater with the media material.

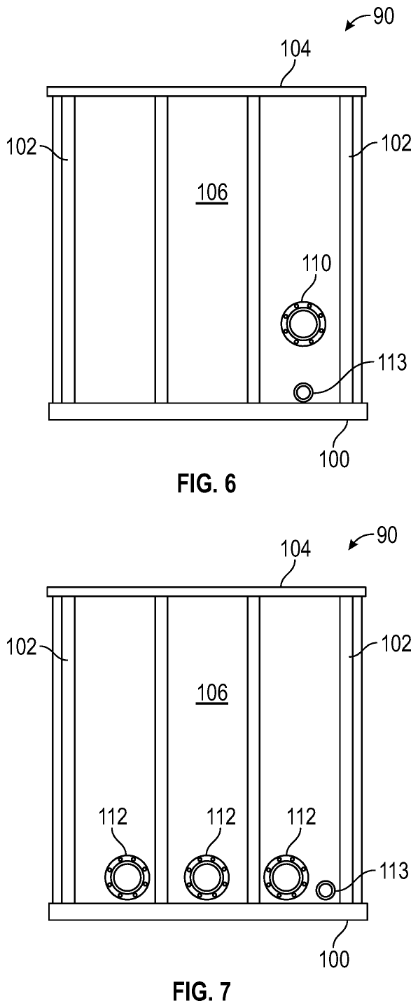

FIGS. 6 and 7 show respective inlet end and outlet end views of the media tank 90. These end views also show one or more drain connections 113 that can be used to drain the tank for purposes of solids or sludge removal or other maintenance that may be required. The three outlet connections 112 are shown as being spaced from one another across the width of the tank 90. Having a plurality of outlets helps to facilitate adequate flow of the wastewater through the device considering there is an appreciable amount of velocity loss of the wastewater as it passes through the device.

Although three passageways are shown, it should be understood that the example flow path of the wastewater through the three passageways can be modified to facilitate a desired retention time and contact of the wastewater with the media material. Accordingly, it is contemplated that more than three or less than three passageways can be incorporated within the media tank 90. The flow of the wastewater through the media tank may alternatively be described as serpentine flow path or serpentine pattern.

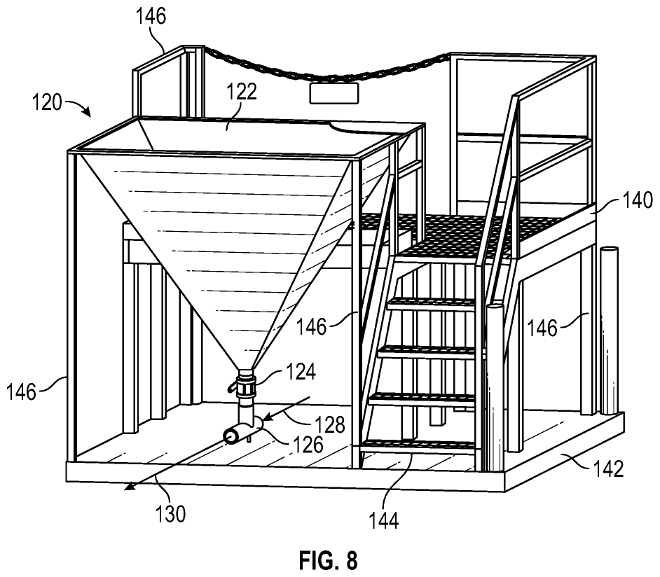

FIG. 8 shows a media mover device of the system of the invention in which media material is loaded and transferred to the media tanks 90. Specifically, FIG. 8 shows the media mover device 120 with a loading bin or hopper 122 which receives a quantity of media material to be transferred. The hopper is supported by a frame structure including a plurality of supports 146 and a base 142. The loading of the hopper may be facilitated by an elevated loading platform 140 which is accessed by a set of stairs 144. A user secures a quantity of media material (not shown) and dumps the media material in the open top end of the hopper 122. The lower end of the hopper 122 is connected to an eductor 126 which, by a venturi effect, transports the media material through a stream of water which passes through the eductor 126 and downstream by a series of pipes (not shown) to replace or replenish media material within the media tanks 90. A flow of water 128 is received into the eductor on the upstream side and the downstream side of the eductor includes a flow of the water and media material 130 passing through the eductor to the media tanks. A valve 124 is located between the bottom end of the hopper 122 and the eductor to control the rate at which the media material is fed by gravity into the eductor. The use of the media mover device provides an efficient and labor savings way of transporting media material to the media tanks. Because the media material can be uniformly suspended in the water that transports the media material to the media tanks, the amount and distribution of the media material within the media tanks can be controlled without significant manual labor or intervention.

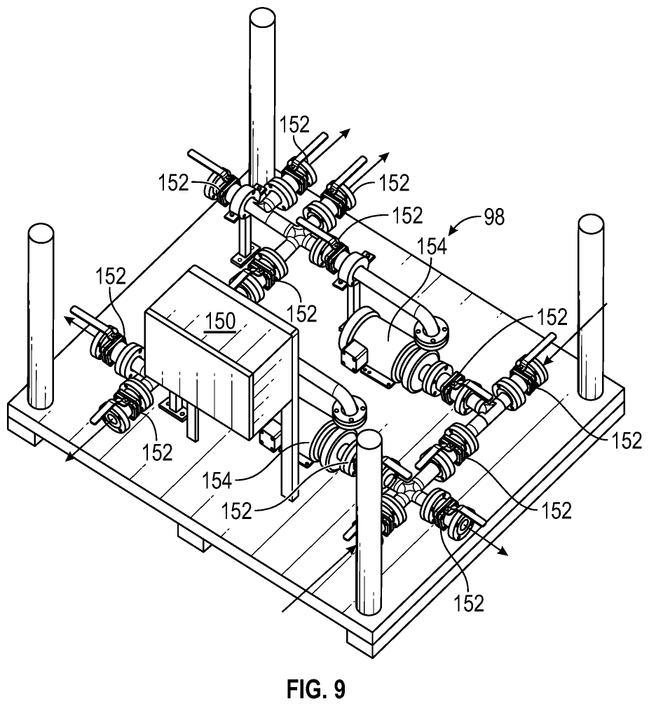

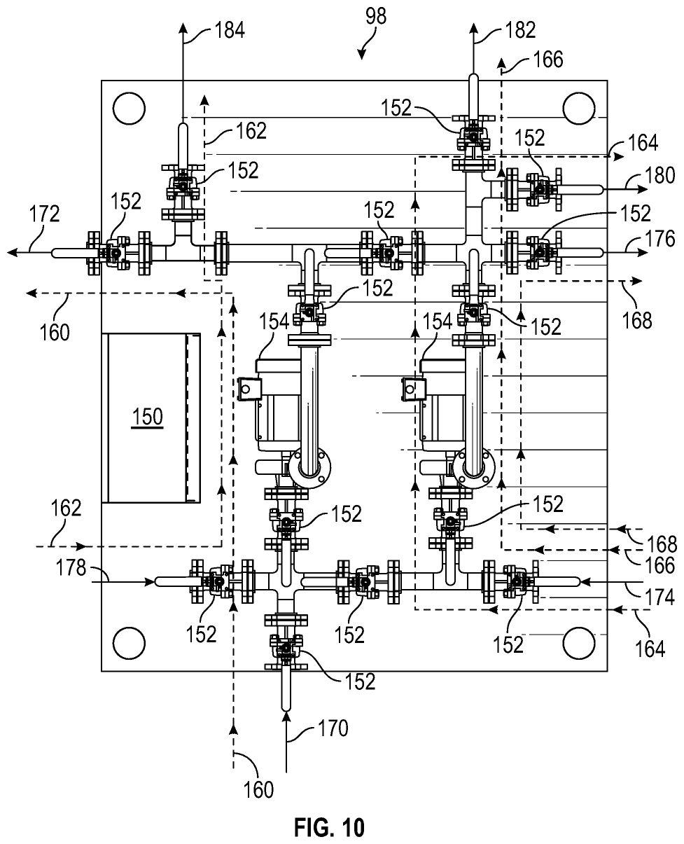

FIGS. 9 and 10 show a pumping station or pump skid 98 for routing and control of make-up water from the media mover 120 for loading the filter tanks with filter media, make-up water for preparing brine water for regeneration of the media in the filter tanks, recirculation of brine water through the filter media tanks and unloading of the brine in the filter media tanks to a truck/trailer for haul and disposal. FIG. 9 is a perspective view of the pump skid 98 and FIG. 10 is a schematic plan view of the pump skid 98. Also referencing FIG. 3, it is shown that the pump skid 98 is located generally between the media mover 120 and the brine tank 96. The specific routing of the water/fluid through the pump station is set forth below in the discussion if FIG. 10. Generally, FIG. 9 shows a plurality of valves 152 and interconnecting pipes or lines. The water that flows through the pump station 98 and to the media mover to be mixed with the media material at the media mover 120 is referred to herein as the “make-up” water, which can be water obtained from an offsite water source. FIG. 9 also illustrates two pumps 154 used to help convey make-up water through the pump station 98. A control panel 150 is shown mounted on the pump skid. The control panel 150 may represent a pump control device used to control the displacement and/or the speed of the pumps 154. For example, a pump control can be used to ensure there is adequate flow rates and water pressures for the makeup water that is flowing through the pump station. The pump controller typically has its own microprocessor and input sensors which monitor the flow of liquid through the pump station. The pump controller may also include various connected field outputs, such as one or more solenoids and pressure switches that may be used to control the various valves 152 and the pumps 154.

Referring to FIG. 10, this schematic view illustrates four circulation routes or paths of fluid through the pump station 98. A first circulation route is denoted by path or route 160 in which make-up water is received through inlet 170 and is transported downstream to the media mover device 120 through outlet 172. In this circulation route, the make-up water therefore flows first through two valves 152, then through a pump 154, then makes a left turn as the pump station 98 is oriented in FIG. 10, then through another valve 152 before exiting the pump skid through outlet 172. The other circulation routes that may intersect with the route 160 have their corresponding valves in those circulation routes closed so that the flow of the make-up water is isolated through the route 160. A second circulation route is denoted by path or route 162 in which media material suspended in a flow of water enters the pump station through inlet 178 and is pumped downstream and out of the pump station through outlet 184. In this circulation route, the suspended media material takes a left turn after passing through a first valve 152, then passes through another valve 152, through a pump 154, through another valve 152, taking another left turn, then taking a right turn through yet another valve 152, and then through the outlet 184. Again, other circulation routes that intersect with the route 162 have their corresponding valves closed so that the suspended media material is isolated through the route 162. A third circulation route is denoted by path or route 164 in which spent or waste media material and waste brine from the brine water mix tank is transported downstream to a waste dump. The waste brine and media material enter the pump station through inlet 174, through a first valve 152 then taking a right turn through another valve 152, then through a pump 154, then through another valve 152, then taking another right turn through a valve 152, and finally through outlet 180. Once again, other circulation routes that intersect with the route 164 have their corresponding valves closed so that the waste brine and suspended media material is isolated through the route 164. A fourth circulation route is denoted by path or route 168 in which brine from the brine water mix tank is recirculated back to the brine water mix tank. Specifically, the brine enters the pump station through inlet 174, through a first valve 152 then taking a right turn through another valve 152, then through a pump 154, then through another valve 152, then taking another right turn through a valve 152, and finally through outlet 176. Once again, any other circulation routes that intersect with the route 168 have their corresponding valves closed so that the brine is isolated through the route 168. It is evident that the provision of the pump skid provides a convenient central location for which to monitor and control fluid flowing through the system. Therefore, instead of having separate circulation routes at various isolated locations within the system, the pump skid provides control for many different circulation routes or flow paths with a minimum number of valves and lengths of piping. In summary, the pump skid 98 is used to load media into the media filter tanks 90 through the media mover, load brine into the brine tank 96, recirculate brine through the media filter tanks 90 and to pump brine out of the brine tank 96 for disposal.

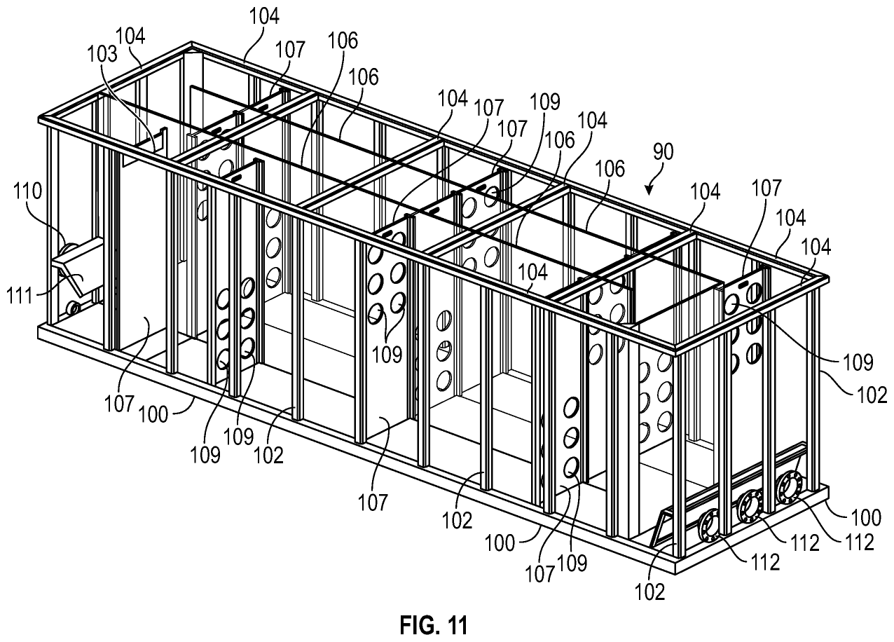

FIG. 11 shows a perspective view of another embodiment of the media bed container or media tank of the invention, again with the sidewalls of the tank removed to show a plurality of diverter plates 107 used within the flow passages or passageways of the tank. The plurality of diverter plates 107 are each shown with a plurality of corresponding flow openings 109 through which the contaminant stream or fluid is allowed to flow. Within each diverter plate 107 as shown, the plurality of openings 109 can be spaced laterally and vertically from one another. The primary purpose of the diverter plates 107 with openings 109 is to provide better mixing of the contaminant fluid stream with the media material as the contaminant fluid flows through the media tank. This figure more specifically shows at least one diverter plate 107 extending laterally across each of the passageways within the media tank so that the fluid stream must pass through many openings 109 as the fluid moves downstream. It is further shown that the openings 109 may be located at different heights or depths within the media tank which further ensures there is no stratification of the liquid therefore, significant mixing is created within the media tank. The mixing created in the media tank by the diverter plates 107 and openings 109 increases the dwell time of the liquid within the tank and therefore also slows the velocity of the liquid. The number of diverter plates 107 and corresponding openings 109 can be selected to optimize the dwell time of the liquid so that optimal treatment can occur within the tank by selective mixing of the wastewater with the media material. It is also contemplated that the sizes of the openings 109 can be the same or different for each of the diverter plates 107 which provides yet further options for increasing or decreasing the velocity of the fluid through the tank. It is further contemplated that there can be more than one opening 109 formed in any one of the diverter plates 107 to provide yet further control of the flow of the wastewater through the media tank.

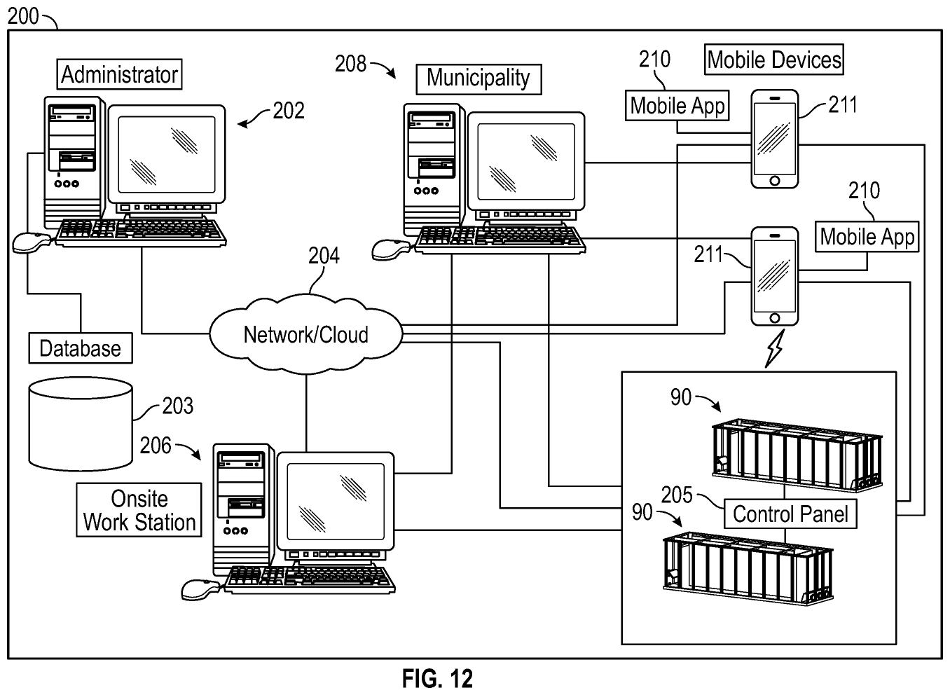

FIG. 12 shows a communication and control system of the invention. As mentioned, the system of the invention may be controlled automatically, manually, or by a combination of the two. According to a preferred embodiment of the communication and control system 200 of FIG. 12, an optional and exemplary computer processing and communication network that may be used in connection with the invention. More specifically, FIG. 12 illustrates a block diagram of a system 200 that includes one or more user computers shown as an administrator computer 202, a user computer 208, such as a computer located at a municipality organization that owns and controls the system; and an onsite work-station computer 206 that could be installed where the system is located so that an operator of the system could monitor and control the components of the system. Alternatively, each of the computers 202, 206 and 208 may comprise more than one computer.

FIG. 12 also schematically illustrates a plurality of the media tanks 90 along with a local control panel 205 that can be used to provide control over functioning of the media tanks. The media tanks and/or the control panel may be equipped with a Bluetooth or wirelessly transmitting capability to transmit wireless signals to one or more mobile communication devices 211. The media tank may be equipped with a number of sensors, such as flowmeters, water level sensors, water quality sensors and others that can be used to determine the status of wastewater flowing through the tanks. The media tanks communicate with the control panel 205 which in turn, can communicate with all of the other components of the system 200.

Each of the mobile communication devices 211 may operate to run their own mobile application or “app” 210, such as to process the data received from the control panel 205 and to generate optional monitoring and control options for a user of the app to control the media tanks 90 and any other component of the treatment system 40. The processed data may further include data stored in the local database of each of the communication devices regarding an operational status of the treatment system 40. The control panel 205 communicates with a network/cloud 204 as by a web interface. The network 204 may also represent a cloud provider that facilitates communication with any or all communication endpoints shown in the communication system 200. The mobile devices 211 may communicate with any other of the computers in the system through the network 204 as shown.

The mobile devices 211 have their own internal computer processing capabilities with integral computer processors and other supporting hardware and software. The mobile devices may be specially configured to run the mobile software applications in order to view user interfaces and to view and update system data. All of the functionality associated with the system as applied to the computers 202, 206 and 208 may be incorporated in the mobile devices 211 as modified by mobile software applications especially adapted for the mobile device hardware and operating systems. In connection with operating systems, it should therefore be understood that the mobile devices 211 are not limited to any particular operating system, Apple iOS and Android-based systems being but two examples.

The municipality computer 208 represents one or more computers used in in the wastewater system 40 environment used to allow monitoring of the operation of the system 40 and to allow for a predetermined level of automatic control of the system. The computer 208 may have its own operational software or viewing and monitoring treatment system 40 to include the monitoring of critical contaminant parameters that may be under state or federal regulatory requirements. The administrator computer 202 may be a computer that controls the communication system 200 including the monitoring and controlling the treatment system 40 and to provide an indication of the functioning of the treatment system. The administrator computer 202 may further provide for security measures associated with the communication system 200 to include providing user authorizations throughout the communication system. The on-site workstation computer 206 represents one or more computers used in the environment of the treatment system 40 that may be used to monitor and troubleshoot treatment system operation and malfunctions. These user computers 202, 206 and 208 may comprise general purpose personal computers (including, merely by way of example, personal computers and/or laptop computers running various versions of Microsoft's Windows® and/or Apple® operating systems) and/or workstation computers running any of a variety of commercially-available LINUX®, UNIX® or LINUX®-like operating systems. These user computers 202, 206 and 208 may also have any of a variety of applications, including for example, database client and/or server applications, and web browser applications. Alternatively, the user computers 202, 206 and 208 may be any other electronic device, such as a thin-client computer, Internet-enabled mobile telephone, and/or personal digital assistant, capable of communicating via a network and/or displaying and navigating web pages or other types of electronic documents.

The system 200 may be further defined as incorporating the communications network 204 that has the capability of facilitating communications between the communication endpoints in a variety of different technologies. The network 204 may be any type of network familiar to those skilled in the art that can support data communications using any of a variety of commercially-available protocols, including without limitation TCP/IP, SNA, IPX, AppleTalk®, and the like. Merely by way of example, the communications network 204 maybe a local area network (“LAN”), such as an Ethernet network, a Token-Ring network and/or the like; a wide-area network; a virtual network, including without limitation a virtual private network (“VPN”); the Internet; an intranet; an extranet; a public switched telephone network (“PSTN”); an infra-red network; a wireless network (e.g., a network operating under any of the IEEE 802.11 suite of protocols, the Bluetooth™ protocol known in the art, and/or any other wireless protocol); and/or any combination of these and/or other networks.

The administrator computer 202 may alternatively represent a server computer. One type of server may include a web server used to process requests for web pages or other electronic documents from the mobile devices 211 and computers 206 and 208. The web server can be running an operating system including any of those discussed above, as well as any commercially-available server operating systems. The web server can also run a variety of server applications, including HTTP servers, FTP servers, CGI servers, database servers, Java servers, and the like. In some instances, the web server may publish operations available as one or more web services.

The system 200 may also include one or more file and/or application servers, which can, in addition to an operating system, include one or more applications accessible by a client running on one or more of the mobile devices 211 and computers 202, 206 and 208. The file/application server(s) may be one or more general purpose computers capable of executing programs or scripts in response to the mobile devices 2111 and user computers 202, 206 and 208. As one example, the server may execute one or more web applications. The web application may be implemented as one or more scripts or programs written in any programming language, such as Java®, C, C#™ or C++, and/or any scripting language, such as Perl, Python, or TCL, as well as combinations of any programming/scripting languages. The application server(s) may also include database servers, including without limitation those commercially available from Oracle®, Microsoft, Sybase®, IBM® and the like, which can process requests from database clients running on a user computer.

The system 200 may also include a database 20 for storing all data associated with running the mobile apps 212 and running any other computer programs associated with user interfaces provided to a user regarding the functions relating to the operation and status of the treatment system 40. The database may reside in a variety of different locations. By way of example, database 203 may reside on a storage medium local to (and/or resident in) one or more of the computers 202, 206 and 208. Alternatively, it may be remote from any or all of the computers 202, 206 and 208 and in communication (e.g., via the network 204) with one or more of these. In a particular set of embodiments, the database 203 may reside in a storage-area network (“SAN”). Similarly, any necessary files for performing the functions attributed to the mobile devices 211 and computers 202, 206 and 208 may be stored locally on the respective mobile devices or computers and/or remotely, as appropriate. The database 203 may be a relational database, such as Oracle® database, which is adapted to store,

In accordance with any of the computers 202, 206 and 208, these may be generally described as general-purpose computers with elements that cooperate to achieve multiple functions normally associated with general purpose computers. For example, the hardware elements may include one or more central processing units (CPUs) for processing data. The computers 202, 206 and 208 may further include one or more input devices (e.g., a mouse, a keyboard, etc.); and one or more output devices (e.g., a display device, a printer, etc.). The computers may also include one or more storage devices. By way of example, storage device(s) may be disk drives, optical storage devices, solid-state storage device such as a random-access memory (“RAM”) and/or a read-only memory (“ROM”), which can be programmable, flash-updateable and/or the like.

Each of the computers and servers described herein may include a computer-readable storage media reader; a communications peripheral (e.g., a modem, a network card (wireless or wired), an infra-red communication device, etc.); working memory, which may include RAM and ROM devices as described above. The server may also include a processing acceleration unit, which can include a DSP, a special-purpose processor and/or the like.

The computer-readable storage media reader can further be connected to a computer-readable storage medium, together (and, optionally, in combination with storage device(s)) comprehensively representing remote, local, fixed, and/or removable storage devices plus storage media for temporarily and/or more permanently containing computer-readable information. The computers and serve permit data to be exchanged with the network 110 and/or any other computer, server, or mobile device.

The computers and server also comprise various software elements and an operating system and/or other programmable code such as program code implementing a web service connector or components of a web service connector. It should be appreciated that alternate embodiments of a computer may have numerous variations from that described above. For example, customized hardware might also be used and/or particular elements might be implemented in hardware, software (including portable software, such as applets), or both. Further, connection to other computing devices such as network input/output devices may be employed.

It should also be appreciated that the methods described herein may be performed by hardware components or may be embodied in sequences of machine-executable instructions, which may be used to cause a machine, such as a general-purpose or special-purpose processor or logic circuits programmed with the instructions to perform the methods. These machine-executable instructions may be stored on one or more machine readable mediums, such as CD-ROMs or other type of optical disks, ROMs, RAMs, EPROMs, EEPROMs, magnetic or optical cards, flash memory, or other types of machine-readable mediums suitable for storing electronic instructions. Alternatively, the methods may be performed by a combination of hardware and software.

The term “software” as used herein shall be broadly interpreted to include all information processed by a computer processor, a microcontroller, or processed by related computer executed programs communicating with the software. Software therefore includes computer programs, libraries, and related non-executable data, such as online documentation or digital media. Executable code makes up definable parts of the software and is embodied in machine language instructions readable by a corresponding data processor such as a central processing unit of the computer. The software may be written in any known programming language in which a selected programming language is translated to machine language by a compile, interpreter or assembler element of the associated computer.

Considering the foregoing exemplary computer and communications network and elements described therein, in connection with one embodiment of the invention, it may also be considered a software program or software platform with computer coded instructions that enable execution of the functionality associated with the functions described with respect to the operation and control of the treatment system 200. User interfaces may be developed for use on the user computers 202, 206 and 208 and mobile devices 211 that incorporate the functionality associated with the operation and control. More specifically, the invention may be considered a software program or software platform that enables monitoring and control of all aspects of the treatment system 40. The software program or platform may further include automatic alarm conditions that may be displayed to a user, such as a municipality employee, or displayed to an operator/technician of the treatment system. The alarms can be automatically generated based on predetermined logic associated with monitored treatment system parameters.

In connection with another embodiment of the invention, it may be considered a combined software and hardware system including (a) a software program or software platform with computer coded instructions that enable execution of the functionality associated with the operation and monitoring of the treatment system 40.

In connection with yet another embodiment of the invention, it may be considered a sub-combination including one or more user interfaces generated by the software for display on the mobile devices 211 and user computers 202, 206 and 208.

While the invention is described herein with respect to multiple preferred embodiments, it should be understood that the invention is not strictly limited to these embodiments and therefore, the invention in totality should be considered commensurate with the scope of the claims appended hereto.

What is claimed is:

1. A system for water treatment comprising:
an aerobic pre-treatment station comprising at least one fluid containment cell which holds and circulates wastewater to be treated therein, said aerobic pre-treatment station including a selected quantity and concentration of single cell algae introduced into the wastewater wherein said algae facilitates aerobic treatment of the wastewater;
an electrocoagulation unit that receives wastewater from said aerobic pretreatment station, said electrocoagulation unit providing further treatment of the wastewater to remove selected contaminants;
a post reaction tank for receiving the wastewater from said electrocoagulation unit, said post reaction tank having means for agitating the wastewater therein to disperse active flocculate introduced from said electrocoagulation unit and to subsequently de-aerate the wastewater;
a clarifier tank for receiving the wastewater from said post reaction tank, wherein said clarifier tank separates solids from liquid in said wastewater and said solids settle out of the wastewater and are collected on a bottom surface of said clarifier tank;
a sand filter for receiving a pressurized flow of said wastewater from said clarifier tank, said sand filter causing further removal of total suspended solids by pressurization of the wastewater flow through said sand filter;
a media tank for receiving the wastewater from said sand filter, said media tank having a plurality of passageways in which said passageways direct flow of the wastewater therethrough, said media tank being selectively loaded with a quantity of microporous material for absorbing contaminants including cations; and
wherein said plurality of passageways being arranged such that wastewater flows through a first passageway of said plurality of passageways in one direction, and the wastewater flows through a second passageway in a substantially opposite direction, and further wherein said wastewater flows in a curved pattern between a downstream end of said first passageway and an upstream end of said second passageway.

2. A non-transitory computer-readable medium containing computer executable instructions, wherein, when executed by a computer processor, the instructions cause the computer processor to execute a method for conducting water treatment of a wastewater stream or flow within a wastewater treatment system, the computer-readable instructions comprising:
instructions to monitor and control an aerobic pre-treatment station comprising at least one fluid containment cell which holds wastewater to be treated therein, said aerobic pre-treatment station including a selected quantity and concentration of single cell algae introduced into the wastewater wherein said algae facilitates aerobic treatment of the wastewater;
instructions to monitor and control an electrocoagulation unit that receives wastewater from said aerobic pretreatment station; instructions to monitor and control the electrocoagulation conducted in said electrocoagulation unit to provide further treatment of the wastewater to remove selected contaminants;
instructions to monitor and control a post reaction tank for receiving the wastewater from said electrocoagulation unit to disperse active flocculate introduced from said electrocoagulation unit and to subsequently de-aerate the wastewater;
instructions to monitor and control a clarifier tank for receiving the wastewater from said post reaction tank;
instructions to monitor and control the separation of solids from liquid in the wastewater while the wastewater resides in the clarifier tank;
instructions to monitor and control a sand filter for receiving the wastewater from said clarifier tank wherein a pressurized flow of the wastewater through said sand filter causes further removal of contaminants;
instructions to monitor and control a media tank for receiving the wastewater from said sand filter, said media tank having a plurality of passageways in which said passageways direct flow of the wastewater there through;
instructions to monitor and control loading of said media tank with a selected quantity of microporous material for absorbing contaminants; and
instructions to generate a plurality of outputs to one or more user screens on one or more computing devices that run said non-transitory computer-readable medium, said outputs including visual displays that show (a) a status of each selected component of said treatment system (b) an alarm status for any of said components that may not be operating within predetermined parameter; and (c) an indication of the volume of wastewater being treated and discharged from the treatment system.

3. The non-transitory computer-readable medium as claimed in claim 2, further including: instructions to monitor and control regeneration of microporous material by use of a solution carried to said media tank.

4. The non-transitory computer-readable medium as claimed in claim 2, further including: instructions to monitor and control a media mover which controls transfer and loading of media material to said media tank.

5. The non-transitory computer-readable medium as claimed in claim 2, further including: instructions to monitor and control a pump station that facilitates the transfer of a solution to regenerate the microporous material in said media tank.

6. A system for water treatment comprising:
an aerobic pre-treatment station comprising at least one fluid containment cell which holds and circulates wastewater to be treated therein, said aerobic pre-treatment station including a selected quantity and concentration of algae introduced into the wastewater wherein said algae facilitates aerobic treatment of the wastewater;
an electrocoagulation unit that receives wastewater from said aerobic pretreatment station, said electrocoagulation unit providing further treatment of the wastewater to remove selected contaminants;
active flocculate introduced from said electrocoagulation unit and to subsequently de-aerate the wastewater;
a clarifier tank for receiving the wastewater from said electrocoagulation unit, wherein said clarifier tank separates solids from liquid in said wastewater and said solids settle out of the wastewater and are collected on a bottom surface of said clarifier tank;
a media tank for receiving the wastewater from said clarifier tank, said media tank having a plurality of passageways in which said passageways direct flow of the wastewater therethrough, said media tank being selectively loaded with a quantity of microporous material for absorbing contaminants including cations; and
wherein said plurality of passageways being arranged such that wastewater flows through a first passageway of said plurality of passageways in one direction, and the wastewater flows through a second passageway in a substantially opposite direction, and further wherein said wastewater flows in a curved pattern between a downstream end of said first passageway and an upstream end of said second passageway; and
wherein said media tank includes a plurality of diverter plates each with a corresponding flow opening through which the wastewater flows through.

7. The system for water treatment, as claimed in claim 6, further including:
a pump station integrated in said system; and
a media mover communicating with said media tank, wherein said pump station facilitates routing and control of make-up water from the media mover for loading of media material into said media tank;

8. A method for water treatment comprising:
providing an aerobic pre-treatment station comprising at least one fluid containment cell which holds wastewater to be treated therein, said aerobic pre-treatment station including a selected quantity and concentration of single cell algae introduced into the wastewater wherein said algae facilitates aerobic treatment of the wastewater;
continuously circulating the wastewater in said fluid containment cell to optimize contact of the wastewater with the algae;
providing an electrocoagulation unit that receives wastewater from said aerobic pretreatment station;
conducting electrocoagulation in said electrocoagulation unit to provide further treatment of the wastewater to remove selected contaminants;
providing a clarifier tank for receiving the wastewater from said electrocoagulation unit;
separating solids from liquid in the wastewater while the wastewater resides in the clarifier thank;
collecting the solids that settle out of the wastewater on a bottom surface of said clarifier tank;
providing a media tank for receiving the wastewater from said clarifier tank, said media tank having a plurality of passageways in which said passageways direct flow of the wastewater there through;
loading said media tank with a selected quantity of microporous material for absorbing contaminants including cations;
providing a first passageway of said plurality of passageways causing the wastewater to flow in one direction;
providing a second passageway of said plurality of passageways causing the wastewater to flow in a substantially opposite direction; and
providing a curved passageway located between a downstream end of said first passageway and an upstream end of said second passageway causing the wastewater to flow in a curved pattern there through.

9. The method, as claimed in claim 8, further including:
providing a sand filter for receiving the wastewater and providing a pressurized flow of the wastewater through said sand filter causing further removal of contaminants including TSS.

10. The method, as claimed in claim 8, further including:
providing a post reaction tank for receiving the wastewater and agitating the wastewater in said post reaction tank to disperse active flocculate introduced from said electrocoagulation unit and to subsequently de-aerate the wastewater.

11. The method, as claimed in claim 8, further including:
regenerating said microporous material by contact with a brine solution.

12. A media tank for treatment of wastewater within a water treatment system, said media tank comprising:
a plurality of passageways that direct flow of the wastewater through the media tank;
said media tank being selectively loaded with a quantity of microporous material for absorbing contaminants; and
wherein said plurality of passageways are arranged such that the wastewater flows through said plurality of passageways in differing directions to increase the amount of time in which the wastewater is exposed to the microporous material.

13. The media tank, as claimed in 12, wherein:
said media tank includes an inlet, an outlet, a base, exterior walls mounted on said base, and interior walls arranged within said exterior walls, wherein said plurality of passageways are formed by said interior walls and said exterior walls.

14. The media tank, as claimed in 12, wherein said media tank further includes:
a first passage wall located in said media tank that defines an equalization chamber and an adjustable weir that allows flow of the wastewater into a first compartment of the media tank.

15. The media tank, as claimed in 12, wherein said media tank further includes:
a diverter plate located in said media tank to slow a velocity of incoming wastewater and to facilitate settlement of solids.

16. The media tank, as claimed in 15, wherein:
said diverter plate includes at least one opening formed therein to increase mixing of the wastewater as it passes through the media tank.

17. The media tank, as claimed in 15, wherein:
said diverter plate includes a plurality of diverter plates located in said media tank and selectively positioned within said plurality of passageways.

18. The media tank, as claimed in 15, wherein:
said at least one opening includes a plurality of openings formed in said diverter plate.

19. The media tank, as claimed in 12, wherein:
flow of the wastewater through the media tank is achieved in a serpentine pattern.

20. The media tank, as claimed in 12, wherein:
flow of the wastewater through the media tank is achieved by a plurality of interconnected straight passageways and bends.

21. The media tank, as claimed in 12, wherein:
said microporous material includes zeolite.
